(19) United States
(12) Patent Application Publication
(10) Pub. No.: US 2011/0032282 A1
(43) Pub. Date: Feb. 10, 2011

(54) DISPLAY DEVICE AND DRIVING METHOD THEREOF

(75) Inventors: Naruhiko Kasai, Yokohama (JP); Masato Ishii, Tokyo (JP); Tohru Kohno, Koganei (JP); Hajime Akimoto, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Displays, Ltd.; Canon Kabushiki Kaisha

(21) Appl. No.: 12/849,111

(22) Filed: Aug. 3, 2010

(30) Foreign Application Priority Data
Aug. 7, 2009 (JP) 2009-185306

(51) Int. Cl. G09G 5/10; G09G 3/30

(52) U.S. Cl. 345/690; 345/76

(57) ABSTRACT

A display device is capable of improving display quality. A data line drive circuit outputs a display signal voltage to data lines in a first period. Each pixel holds the display signal voltage with reference to a voltage determined based on characteristics of the drive transistor. In a second period, a control voltage for controlling the drive transistor is output to the data lines. The drive transistor generates a drive current in accordance with the control voltage and the held signal voltage so as to allow the self-luminous element to emit light. After the second period, a third period is provided in which a voltage signal for setting a control terminal of the drive transistor to have a given correction voltage is output to the data lines. The first period follows the third period.

### CROSS-REFERENCE TO RELATED APPLICATION

The present application claims priority from Japanese application JP 2009-185306 filed on Aug. 7, 2009, the content of which is hereby incorporated by reference into this application.

### BACKGROUND OF THE INVENTION

1. Field of the Invention

The present invention relates to a display device and a driving method therefor, and more particularly, to a self-luminous display device equipped with electroluminescence (EL) elements, organic EL elements, or other self-luminous elements serving as self-luminous type display elements, and also to a driving method therefor.

2. Description of the Related Art

Self-luminous elements, typified by EL elements and organic EL elements, have characteristics that they emit light with brightness proportional to the amount of current flowing therethrough, and accordingly gray-scale display is enabled by controlling the amount of current flowing through the self-luminous element. A display device may be manufactured by arranging a plurality of such self-luminous elements.

Meanwhile, there are fluctuations in characteristics among drive transistors for controlling the amounts of current flowing through the self-luminous elements due to non-uniformity in a manufacturing process therefor. The characteristic fluctuations result in fluctuations in drive current of the self-luminous elements, eventually leading to brightness fluctuations among pixels, which are responsible for degrading image quality.

As one of the circuits for solving such a problem, Japanese Patent Application Laid-open No. 2003-5709 discloses the following technology. That is, in each horizontal period (one-line period), a display data signal is written with reference to the characteristics of the drive transistor and thereafter a triangular wave for controlling an emission timing is input, to thereby perform gray-scale display while canceling the characteristic fluctuation of the drive transistor as well as controlling an emission time.

### SUMMARY OF THE INVENTION

The technology disclosed in Japanese Patent Application Laid-open No. 2003-5709 is a driving method called time modulation scheme, in which the emission time is controlled based on a magnitude comparison between a data voltage (signal voltage) and a triangular wave voltage, with a display period divided into a signal write period (signal voltage write period, data write period) and a triangular wave input period (triangular wave voltage input period, emission period, turn-on time). For example, in the driving method, the signal write period and the emission period are separately provided in each frame period or each horizontal period.

In such driving, in order to ensure a long emission time in each frame period, it is necessary to provide a frame memory so that a display period may be reduced to ensure a long blanking period, and hence peripheral circuitry has a large scale. Alternatively, it is conceivable to provide a line buffer to ensure a long emission time in each horizontal period. In fact, however, not all the horizontal blanking period can be set as the emission period. As described later, light emission cannot be performed until a pixel drive voltage (triangular wave) is written in place of the signal voltage, and hence a long emission time cannot be ensured. In addition, there is a fear that fluctuations in write characteristics among the drive transistors and a difference in write condition may lead to fluctuations in drive current of the self-luminous elements, with the result that brightness fluctuations may occur to degrade image quality.

The present invention has been made in view of the above-mentioned problems, and it is therefore an object of the present invention to provide a display device capable of preventing degradation in displayed image quality due to fluctuations in write characteristics among drive transistors or a difference in write condition, and provide a driving method therefor.

(1) In order to solve the above-mentioned problems, there is provided a display device including: a display portion including: a plurality of pixels arrayed in a matrix of rows and columns, the plurality of pixels each including a self-luminous element and a drive element for supplying a current to the self-luminous element; a plurality of data lines for supplying a display signal voltage to the plurality of pixels; and a plurality of scanning lines intersecting with the plurality of data lines; and a data line drive circuit for providing a first period in which the display signal voltage in accordance with display data is output to the plurality of data lines, and a second period in which a control voltage for controlling the drive element to control light emission of the self-luminous element is output to the plurality of data lines, to thereby supply the display signal voltage and the control voltage to the plurality of pixels. The data line drive circuit further provides, after the second period, a third period in which a given voltage signal is applied to a control terminal of the drive element. The data line drive circuit is configured to: output the display signal voltage in accordance with the display data in the first period; output the control voltage for controlling the light emission of the self-luminous element in the second period; and output the given voltage signal for setting the control terminal of the drive element to have a given correction voltage in the third period.

(2) In order to solve the above-mentioned problems, there is provided a driving method for a display device, the display device including: a plurality of pixels arrayed in a matrix of rows and columns, the plurality of pixels each including a self-luminous element and a drive element for supplying a current to the self-luminous element; a plurality of data lines for supplying a display signal voltage to the plurality of pixels; and a plurality of scanning lines intersecting with the plurality of data lines, the driving method including sequentially repeating: a first period in which the display signal voltage in accordance with display data is output to the plurality of data lines; a second period in which a control voltage for controlling the drive element to control light emission of the self-luminous element is output to the plurality of data lines; and a third period in which a given voltage signal is applied to a control terminal of the drive element.

According to the present invention, an emission time may be ensured by a line memory, eliminating the need for a frame memory, to thereby simplify a configuration of peripheral circuitry. Besides, the fluctuations in write characteristics maybe corrected to correct the difference in write condition due to corrective line writing, to thereby perform high-brightness image display.

Other effects of the present invention become clear from the entire description of the specification.

### BRIEF DESCRIPTION OF THE DRAWINGS

In the accompanying drawings:

FIG. 1 is a diagram illustrating a schematic configuration of a display device according to a first embodiment of the present invention;

FIG. 2 is a circuit diagram illustrating an internal configuration of a self-luminous element display included in the display device according to the first embodiment of the present invention;

FIG. 3 is a graph illustrating how to set a reference voltage for a signal voltage of a drive inverter included in the display device according to the first embodiment of the present invention;

FIGS. 4A and 4B are timing charts illustrating a turn-on time control operation performed in a conventional display device, in which data writing and triangular wave input are repeated every horizontal period;

FIGS. 5A and 5B are signal waveform diagrams illustrating a basic concept of an operation in which signal voltage writing and triangular wave voltage writing are repeated in groups with each group made up of a plurality of lines, according to the display device of the first embodiment of the present invention;

FIGS. 6A and 6B are signal waveform diagrams illustrating the operation in which the signal voltage writing and the triangular wave voltage writing are repeated in groups with each group made up of a plurality of lines, according to the display device of the first embodiment of the present invention;

FIGS. 7A to 7C are waveform diagrams illustrating how a horizontal image storage circuit ensures a horizontal blanking period, that is, an emission period according to the display device of the first embodiment of the present invention;

FIG. 8 is a block diagram illustrating an exemplary internal configuration of a data line drive circuit included in the display device according to the first embodiment of the present invention;

FIG. 9 is a block diagram illustrating an exemplary internal configuration of a triangular wave period data generation circuit included in the display device according to the first embodiment of the present invention;

FIG. 10 is a waveform diagram illustrating an operation of the data line drive circuit included in the display device according to the first embodiment of the present invention;

FIGS. 11A and 11B are diagrams illustrating how a gate voltage of the drive inverter fluctuates immediately after light emission in the display device according to the first embodiment of the present invention;

FIG. 12 is a circuit diagram illustrating another exemplary internal configuration of pixels included in the display device according to the first embodiment of the present invention;

FIG. 13 is a circuit diagram illustrating still another exemplary internal configuration of the pixels included in the display device according to the first embodiment of the present invention;

FIG. 14 is a waveform diagram illustrating an operation of a data line drive circuit included in a display device according to a second embodiment of the present invention; and

FIG. 15 is a circuit diagram illustrating an internal configuration of pixels included in the display device according to the second embodiment of the present invention.

### DETAILED DESCRIPTION OF THE INVENTION

Hereinafter, embodiments to which the present invention is applied are described with reference to the accompanying drawings. It should be noted that, in the following description, the same components are denoted by the same reference numerals so that repetitive description thereof is omitted.

### First Embodiment

### [Overall Configuration]

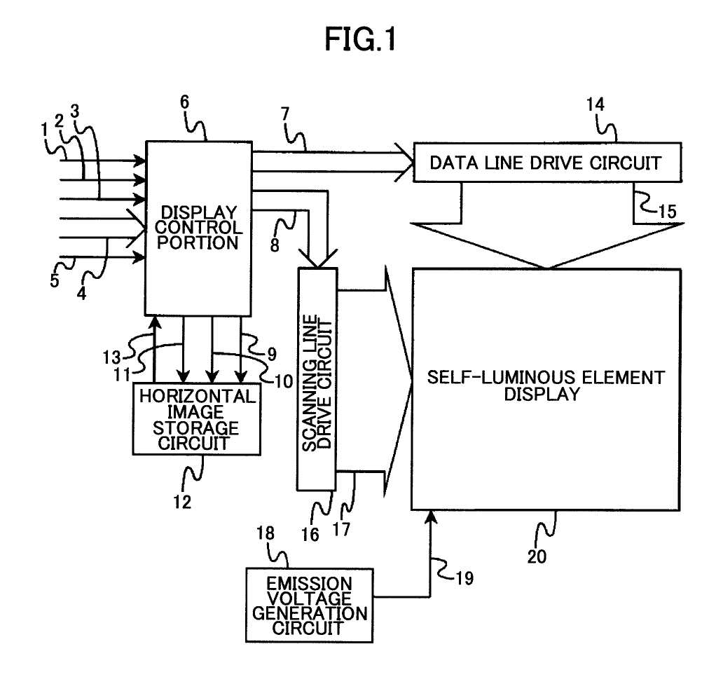

FIG. 1 is a diagram illustrating a schematic configuration of a display device according to a first embodiment of the present invention, in particular, illustrating an embodiment of a configuration of an image display device using self-luminous elements. FIG. 1 illustrates a vertical synchronization signal 1, a horizontal synchronization signal 2, a data enable signal 3, display data 4, a synchronization clock 5, a display control portion 6, a data line control signal 7, a scanning line control signal 8, a storage circuit control signal 9, a storage circuit control address 10, storage data 11, a horizontal image storage circuit 12, read-out data 13, a data line drive circuit 14, a data line drive signal 15, a scanning line drive circuit 16, a scanning line drive signal 17, an emission voltage generation circuit 18, a self-luminous element emission voltage 19, and a self-luminous element display 20.

The vertical synchronization signal 1 is a signal indicating one cycle (one-frame cycle) of a display screen, the horizontal synchronization signal 2 is a signal indicating one horizontal cycle, and the data enable signal 3 is a signal indicating a period (display effective period) in which the display data 4 is effective. All those signals are input in synchronization with the synchronization clock 5. It should be noted that, in this embodiment, the display data 4 for one screen is transferred sequentially in the raster scanning scheme, starting from data on a pixel (not shown) provided at the upper left end of an image. Information on each pixel is constituted by 6-bit digital data.

The horizontal image storage circuit 12 is capable of storing the display data 4 for at least two horizontal scanning lines (two lines) of the self-luminous element display 20 (described in detail later). In this embodiment, the horizontal image storage circuit 12 stores display data for three lines to be read out sequentially.

In temporarily storing the display data 4 into the horizontal image storage circuit 12, the display control portion 6 generates the storage circuit control signal 9 and the storage circuit control address 10 as a write control signal and a write address, respectively, and outputs those signal and address to the horizontal image storage circuit 12 together with the storage data 11. On the other hand, in reading out the storage data 11 in synchronization with a display timing of the self-luminous element display 20 as the read-out data 13, the display control portion 6 generates the storage circuit control signal 9 and the storage circuit control address 10 as a read control signal and a read address, respectively, and outputs those signal and address to the horizontal image storage circuit 12. The display control portion 6 further generates the data line control signal 7 and the scanning line control signal 8 based on the read control signal, the read address, and the read-out data 13, and outputs the generated signals.

The self-luminous element display 20 has a display configuration using light-emitting diodes or organic electroluminescence (EL) elements as display elements, and includes a plurality of self-luminous elements (pixels) (not shown) arranged in matrix. In a display operation of the self-luminous element display 20, in accordance with the data line drive signal 15 output from the data line drive circuit 14, a signal voltage and a triangular wave signal are applied to the pixels on a line selected by the scanning line drive signal 17 output from the scanning line drive circuit 16, to thereby control an emission time of each pixel. The self-luminous element emits light when applied with the self-luminous element emission voltage 19 for the controlled emission time. It should be noted that the data line drive circuit 14 and the scanning line drive circuit 16 may be implemented by separate large scale integrated circuits (LSIs) or a single LSI, and may be formed on the same glass substrate where pixel portions are formed. In this embodiment, the self-luminous element display 20 has a resolution of 240×320 dots.

### [Internal Configuration]

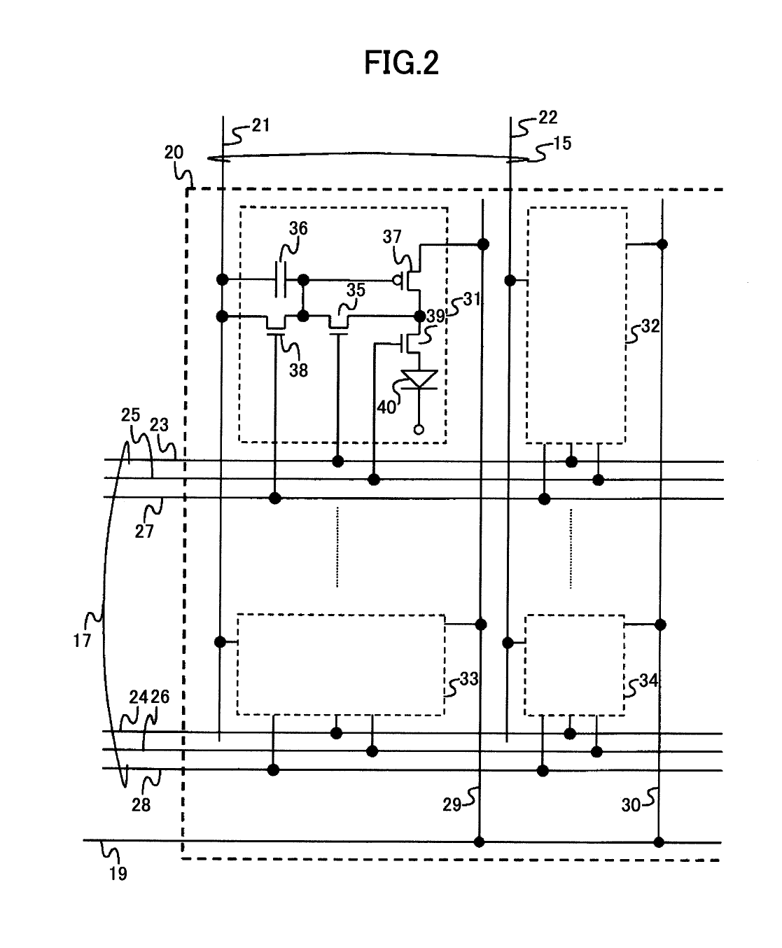

FIG. 2 is a circuit diagram illustrating an internal configuration of the self-luminous element display 20 included in the display device according to the first embodiment of the present invention, illustrating a configuration in which the organic EL elements are used as the self-luminous elements. FIG. 2 illustrates a first data line 21, a second data line 22, a first scanning line 23, a 320th scanning line 24, a first emission control line 25, a 320th emission control line 26, a first correction control line 27, a 320th correction control line 28, an emission voltage supply line for first column 29, an emission voltage supply line for second column 30, a pixel in first row and first column 31, a pixel in first row and second column 32, a pixel in 320th row and first column 33, and a pixel in 320th row and second column 34. The pixels of each row (line) are selected by their corresponding scanning lines. The emission time of each pixel is controlled based on a correlation between the signal voltage and the triangular wave, which are supplied via each data line. It should be noted that FIG. 2 illustrates a pixel internal configuration only about the pixel in first row and first column 31, but the other pixels including the pixel in first row and second column 32 (all the pixels including not-shown pixels) have the same pixel internal configuration. Each pixel has an internal circuit including a reset switch 35, a write capacitor 36, a drive inverter 37, a correction switch 38, an emission control switch 39, and an organic EL element 40.

As illustrated in FIG. 2, in the self-luminous element display 20 according to the first embodiment, one terminal of the drive inverter 37 as a drive element is connected to the emission voltage supply line for first column 29, and another terminal thereof is connected to one terminal of the emission control switch 39 as a switch element. Another terminal of the emission control switch 39 is connected to an anode of the organic EL element 40 as a self-luminous element. A gate terminal of the emission control switch 39 is connected to the first emission control line 25. A cathode of the organic EL element 40 is connected to the ground.

The another terminal of the drive inverter 37 is further connected to one terminal of the reset switch 35. Another terminal of the reset switch 35 is connected to a control terminal (gate terminal) of the drive inverter 37 and one terminal of the write capacitor 36. A control terminal (gate terminal) of the reset switch 35 is connected to the first scanning line 23. Another terminal of the write capacitor 36 is connected to the first data line 21.

The correction switch 38 is characteristic of a drive circuit formed in each pixel of the self-luminous element display 20 according to the first embodiment. One terminal of the correction switch 38 is connected to the control terminal of the drive inverter 37, and another terminal thereof is connected to the first data line 21. A control terminal (gate terminal) of the correction switch 38 is connected to the first correction control line 27.

This way, in the display device according to the first embodiment, a display area of the self-luminous element display 20 is partitioned into a plurality of pixel regions (regions 31 to 34 indicated by the dotted lines of FIG. 2) in the lateral direction (horizontal direction) by the longitudinally-extending data lines and the longitudinally-extending emission voltage supply lines, and in the longitudinal direction (vertical direction) by the laterally-extending scanning lines (including the emission control lines and the correction control lines).

Next, referring to FIG. 2, the display operation of the display device according to the first embodiment is described. The pixels have the same configuration and perform the same operation, and hence in the following, only the display operation of the pixel in first row and first column 31 is described in detail.

The reset switch 35 is turned “ON” by the first scanning line 23 to short-circuit the input and output of the drive inverter 37. When the reset switch 35 is turned “ON”, a reference voltage is set depending on characteristics of transistors forming the drive inverter 37 included in each pixel. With reference to the reference voltage, the write capacitor 36 is charged to the signal voltage supplied from the first data line 21, to thereby write the signal voltage into each pixel.

The drive inverter 37 outputs “Low” when the triangular wave to be input after the writing of the signal voltage is higher than the signal voltage written into the write capacitor 36, and outputs “High” when the triangular wave is lower than the signal voltage.

Upon the input of the triangular wave, the emission control switches 39 of all the pixels are turned “ON”, and hence when the output of the drive inverter 37 becomes “High”, the corresponding organic EL element 40 emits light. After the light emission, the correction switch 38 is turned “ON” to set a gate voltage of the drive inverter 37 to a correction voltage supplied from the first data line 21, to thereby enable the above-mentioned signal voltage write operation to be performed with the same characteristics between a period immediately after the light emission and the remaining period followed by the period.

Meanwhile, as described above, the number of pixels of the self-luminous element display 20 according to the first embodiment is 240×320. As the scanning lines, 320 horizontally-extending signal lines, from the first scanning line 23 to the 320th scanning line 24, are arrayed in the vertical direction. In a case where each pixel of the self-luminous element display 20 is formed of three dots of R, G, and B arranged side by side in the horizontal direction, 720 pixel regions indicated by the dotted lines of FIG. 2 are arranged side by side in the horizontal direction. In this case, as the data lines, 720 vertically-extending signal lines, that is, the first data line 21, the second data line 22, . . . and the 720th data line (not shown) are arrayed in the horizontal direction. Further, the self-luminous element emission voltage 19 is supplied to a signal line disposed in the horizontal direction on the lower side of the self-luminous element display 20. This signal line is connected in common to 720 vertically-extending signal lines (extending in the column direction), that is, the emission voltage supply line for first column 29, the emission voltage supply line for second column 30, . . . and the emission voltage supply line for 720th column, which are arrayed in the horizontal direction.

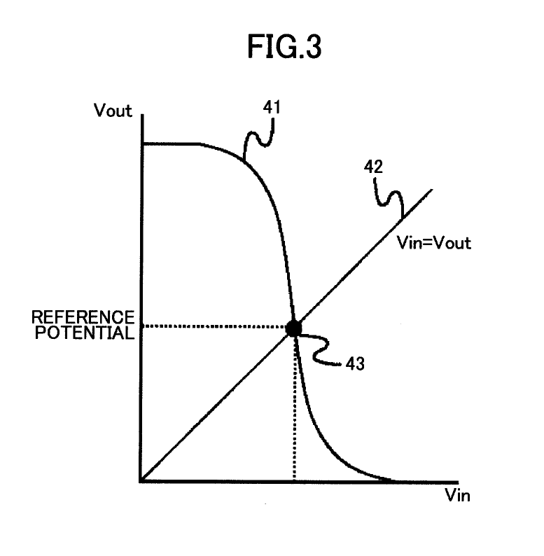

FIG. 3 is a graph illustrating how to set the reference voltage for the signal voltage of the drive inverter 37 included in the display device according to the first embodiment of the present invention. In FIG. 3, an input/output characteristic of the drive inverter 37 is represented by reference numeral 41, an input/output short-circuiting condition is represented by 42, and a signal voltage write reference potential of the drive inverter 37 is represented by 43.

The input and output of the drive inverter 37 are short-circuited by the reset switch 35 being turned “ON” for data writing. As a result, the potentials of the input node and the output node of the drive inverter 37 are set to the signal voltage write reference potential 43, which appears at the intersection between the input/output characteristic 41 and the input/output short-circuiting condition 42 indicated by the straight line of Vin=Vout. The writing of the signal voltage is performed with reference to the signal voltage write reference potential 43.

### [Conventional Emission Operation for Each Line]

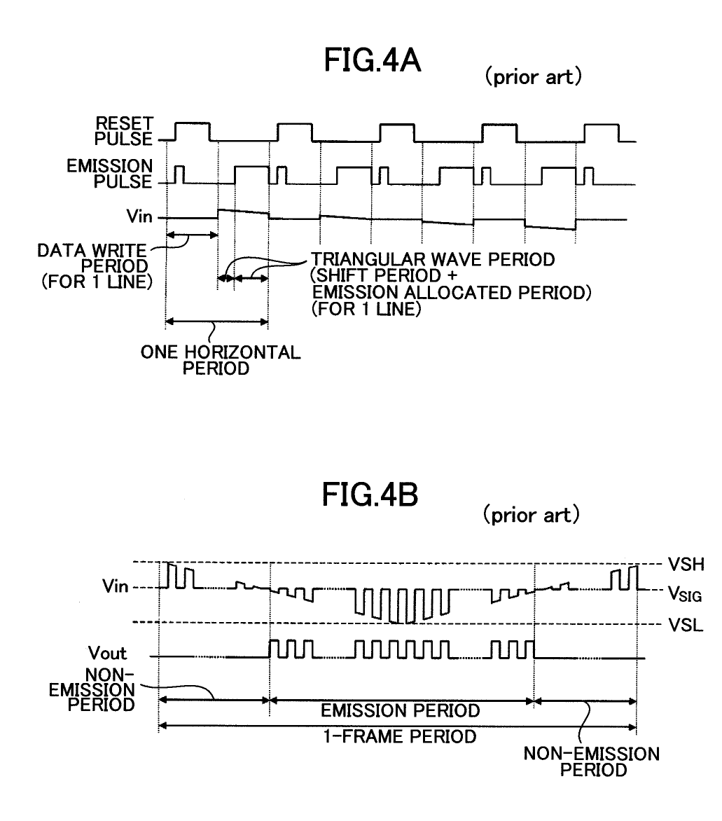

FIGS. 4A and 4B are timing charts illustrating a turn-on time control operation performed in a conventional display device, in which the data writing and the triangular wave input are repeated every horizontal period. FIG. 4A illustrates a turn-on time control operation in one horizontal period, and FIG. 4B illustrates a turn-on/off operation of the self-luminous element in a one-frame period. Referring to FIGS. 4A and 4B, a basic circuit operation of the conventional self-luminous element display is described below.

As illustrated in FIG. 4A, in data writing for one horizontal line, each horizontal period is divided into a data write period and a triangular wave period. In the data write period, a reset pulse is set to “High” to turn “ON” the reset switch 35, and an emission control pulse is set to “High” to turn “ON” the emission control switch 39. In the subsequent triangular wave period, a shift period required for switching an input voltage to a triangular wave voltage is provided, and after the shift period, only the emission control pulse is set to “High”.

In the data write period in which the input voltage is set as a signal voltage (V_{sig}) and the reset pulse and the emission control pulse are set to “High”, the input node voltage of the drive inverter 37 becomes a drive inverter threshold voltage, which is determined based on the characteristics of the drive inverter 37 and the organic EL element 40. The triangular wave voltage applied in the triangular wave periods drops from High in terms of triangular wave to Low in terms of triangular wave over a plurality of lines. Then, the triangular wave voltage rises again from Low in terms of triangular wave to High in terms of triangular wave.

According to the conventional display device illustrated in FIGS. 4A and 4B, the triangular wave changes from High in terms of triangular wave to Low in terms of triangular wave and again to High in terms of triangular wave in a cycle of a one-frame period. The following description is given assuming that the one-frame period is one cycle at a frequency of 60 Hz (about 16.7 ms). In each triangular wave period, the drive inverter output is “1 (representing emission period)” during a period when the triangular wave level falls below the drive inverter threshold voltage, and is “0 (representing non-emission period)” during a period when the triangular wave level exceeds the drive inverter threshold voltage. During a period allocated for light emission (emission allocated period) in each triangular wave period, the emission control pulse is set to “High” to turn “ON” the emission control switch 39. Accordingly, in the emission allocated period, the organic EL element 40 emits light in the emission period, where the drive inverter output is “1”. It should be noted that the conventional display device has no correction switch 38 and no control line related thereto.

### [Emission Operation for Every Two or More Plurality of Lines]

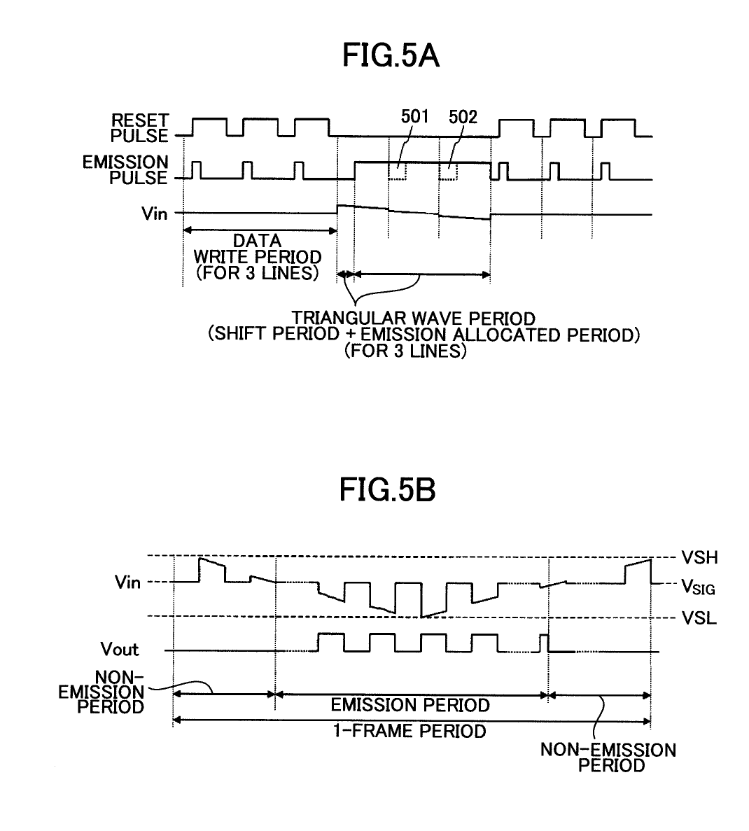

FIGS. 5A and 5B are signal waveform diagrams illustrating a basic concept of an operation in which the signal voltage writing and the triangular wave voltage application are repeated in groups with each group made up of a plurality of lines, according to the display device of the first embodiment. FIG. 5A illustrates a turn-on time control operation corresponding to one group, and FIG. 5B illustrates a turn-on/off operation of the self-luminous element in a one-frame period. Referring to FIGS. 5A and 5B, the basic operation of the self-luminous element display 20 according to the first embodiment, that is, the circuit operation of repeating the signal voltage writing and the triangular wave voltage application for each group of the plurality of lines is described below. The basic operation illustrated in FIGS. 5A and 5B is described differently from an operation according to the first embodiment described later in that an operation of the correction switch 38 is omitted. In this example, every three lines are grouped into one.

A display voltage write period (data write period) is set for three successive lines (three lines in sequence for each line), in which the reset pulse is set to “High” to turn “ON” the reset switch 35. Subsequently, a triangular wave period (triangular wave voltage application period) is set for three lines collectively, in which only the emission control pulse is set to “High”. The operation of the drive inverter 37 on this occasion is the same as the operation described above with reference to FIGS. 4A and 4B, and hence description thereof is omitted. In the triangular wave voltage application period, the second or subsequent application of the triangular wave voltage is switching of the triangular wave voltage itself, and hence it is not necessary to provide a period for the shift from the display voltage (dotted portion 501 or 502 of FIG. 5A). Accordingly, a longer emission allocated period, where the light emission is allowed when the emission control pulse is set to “High”, may be ensured compared with the operation illustrated in FIGS. 4A and 4B.

[Emission Operation with Correction for Every Two or More Plurality of Lines]

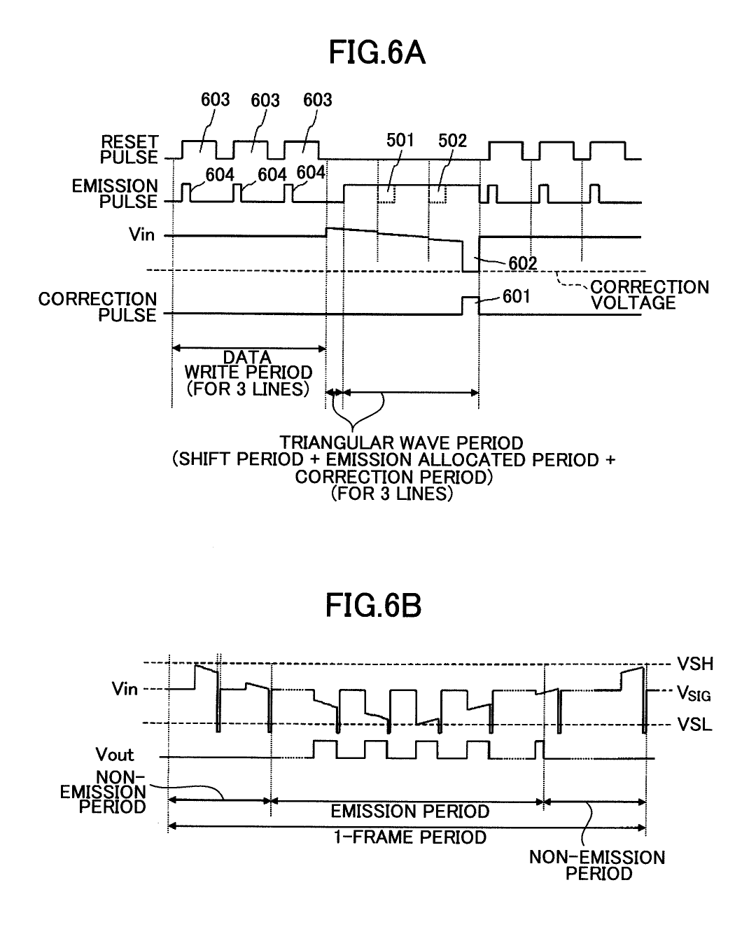

FIGS. 6A and 6B are signal waveform diagrams illustrating the operation in which the signal voltage writing and the triangular wave voltage application are repeated in groups with each group made up of a plurality of lines, according to the display device of the first embodiment of the present invention. FIG. 6A illustrates a turn-on time control operation for three lines corresponding to one group, and FIG. 6B illustrates a turn-on/off operation of the self-luminous element in a one-frame period. The operation illustrated in FIGS. 6A and 6B is an actual operation of the display device according to the present invention, which includes the operation of the correction switch 38 in addition to the basic operation illustrated in FIGS. 5A and 5B.

As illustrated in FIGS. 6A and 6B, in the display device according to the first embodiment, the display voltage write period (data write period, first period) is set for three successive lines (three lines in sequence for each line), in which the reset pulse is set to “High” to turn “ON” the reset switch 35. Subsequently, the triangular wave period (triangular wave voltage application period) is set for three lines collectively, in which only the emission control pulse is set to “High”. Immediately before the end of the triangular wave period, that is, before subsequent display voltage writing, the correction switch 38 is turned “ON” and the voltage Vin is set to GND. This operation enables making constant the gate voltage fluctuation of the drive inverter 37 caused after light emission, to thereby perform the display voltage writing immediately after the light emission and the subsequent display voltage writing with the same characteristics in the display voltage write period. It should be noted that, according to the first embodiment, in order to set the voltage Vin to GND, the data line drive circuit 14 outputs GND as a display voltage.

In other words, in the display device according to the first embodiment, in the data write period for three lines illustrated in FIG. 6A, three reset pulses 603 and three emission control pulses 604 (illustrated as EMISSION PULSE in FIG. 6A) are output so as to correspond to the data writing for three lines. Because of those reset pulses 603 and emission control pulses 604, the voltage of the gate terminal of the drive inverter 37 is set to the signal voltage write reference potential 43.

In the subsequent triangular wave period for three lines, which is made up of the shift period, the emission allocated period (second period), and the correction period (third period), a period since the end of the data write period until the rise of the emission control pulse corresponds to the shift period. The shift period is a period for the shift from the display signal voltage to the triangular wave voltage. Further, a period since the end of the shift period until the input of the correction pulse corresponds to the emission allocated period, and a period in which the correction pulse 601 is input corresponds to the correction period.

As described above, according to the first embodiment, the data write period and the triangular wave period are each set every three lines, and the correction period is provided immediately before the end of the triangular wave period, to thereby correct the gate voltage fluctuation of the drive inverter 37 and reset the emission voltage held in a parasitic capacitor of the organic EL element 40 immediately after light emission.

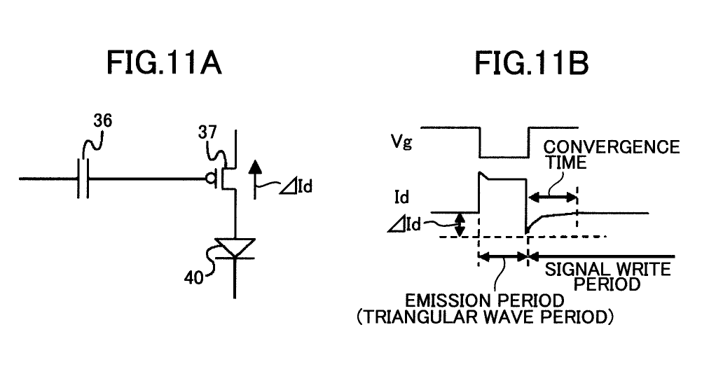

FIGS. 11A and 11B are diagrams illustrating how the gate voltage of the drive inverter 37 fluctuates immediately after light emission in the display device according to the first embodiment of the present invention. FIG. 11A is a circuit diagram in which the arrow represents a current flowing at the end of light emission in the drive inverter 37. FIG. 11B is a signal waveform diagram illustrating how the gate voltage of the drive inverter 37 fluctuates immediately after the light emission.

During the light emission, a current Id flows through the drive inverter 37 toward the organic EL element 40. As illustrated in FIGS. 11A and 11B, at a moment when the light emission ends, the current Id flows in the direction opposite to that during the light emission by an amount of ΔId. As illustrated in FIG. 11B, it takes time until this reverse current ceases (convergence time). The reverse current ΔId converges in the signal write period following the emission period, and the gate voltage of the drive inverter 37 fluctuates because of the reverse current ΔId, with the result that the signal voltage to be written into the write capacitor 36 also fluctuates.

According to the first embodiment, however, as illustrated in FIGS. 6A and 6B, in the correction period within the triangular wave period, the correction pulse 601 is input and the data line voltage is set to the correction voltage, that is, GND. Therefore, after the light emission and before the subsequent data write period, the gate voltage of the drive inverter 37 may be set once to the GND potential (given constant potential, correction voltage). In other words, the gate voltage fluctuation of the drive inverter 37 caused after the light emission may be made constant to enable the display voltage writing to be performed with the uniform characteristics in the data write period.

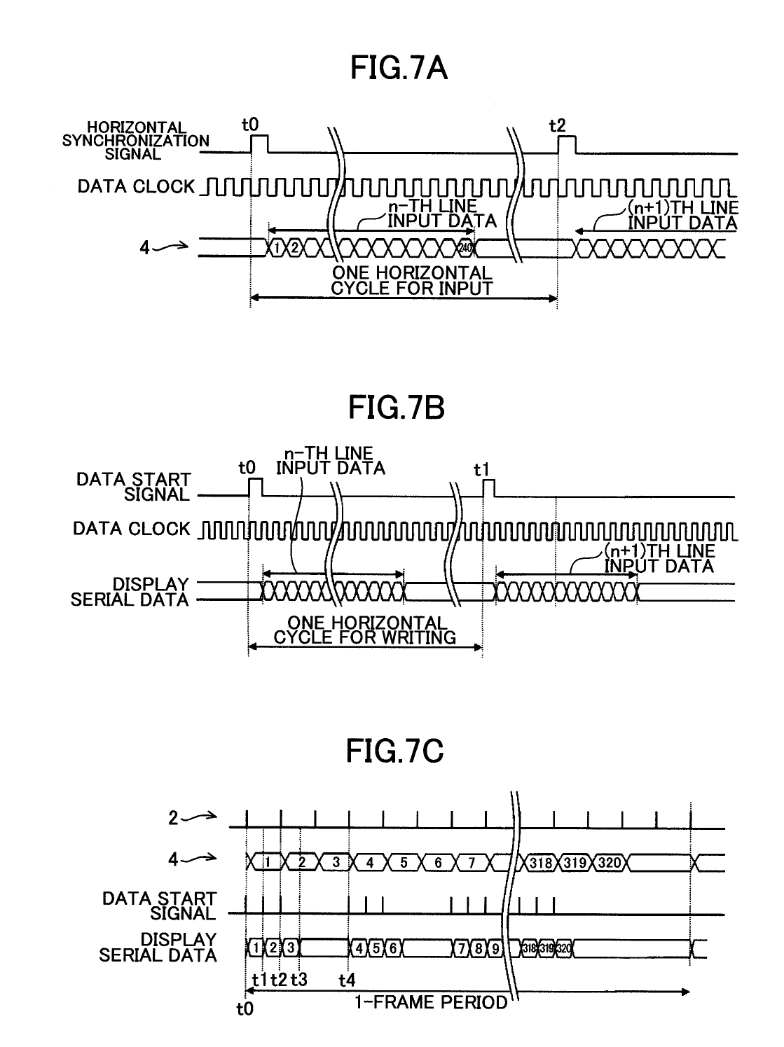

FIGS. 7A to 7C are waveform diagrams illustrating how the horizontal image storage circuit 12 ensures a horizontal blanking period, that is, an emission allocated period according to the display device of the first embodiment of the present invention. FIG. 7A illustrates an input operation of display data in one horizontal period, FIG. 7B illustrates an operation of outputting the input display data of one horizontal period to be written into pixels, and FIG. 7C illustrates a relation between the input operation of display data and the output operation of display serial data in a one-frame period. In FIGS. 7A and 7B, with respect to the input horizontal synchronization signal and data clock signal, a data start signal (described later) and a data clock (described later in detail) are input at a higher frequency. As is apparent from FIG. 7C, according to the first embodiment, write data for three lines is read out in an input period of 1.5 lines, and the remaining period of 1.5 lines is allocated to the horizontal blanking period, that is, the emission allocated period.

In other words, also in the display device according to the first embodiment, as illustrated in FIG. 7A, an external device performs data input of display data for one line (n-th line display data in FIG. 7A) in one horizontal period between times t0 and t2. At this time, the horizontal image storage circuit 12 included in the display device according to the first embodiment temporarily stores display data for three lines (for example, display data from n-th line to (n+2)th line), which is input from the external device. After the display data for three lines is stored in the horizontal image storage circuit 12, the display control portion 6 controls the data line drive circuit 14 and the scanning line drive circuit 16 so that the display data for one line may be written into the pixels on the corresponding line of the self-luminous element display 20, spending a half period of one horizontal period (for example, a period between the times t0 and t1). As a result, as illustrated in FIG. 7C, spending one and a half horizontal period (period between the times t0 and t3), which is a half period of three horizontal periods, the writing of the display data is completed for the pixels on three lines of the self-luminous element display 20. Therefore, as the triangular wave period, one and a half horizontal period between the times t3 and t4 may be allocated for the emission operation of the pixels on three lines.

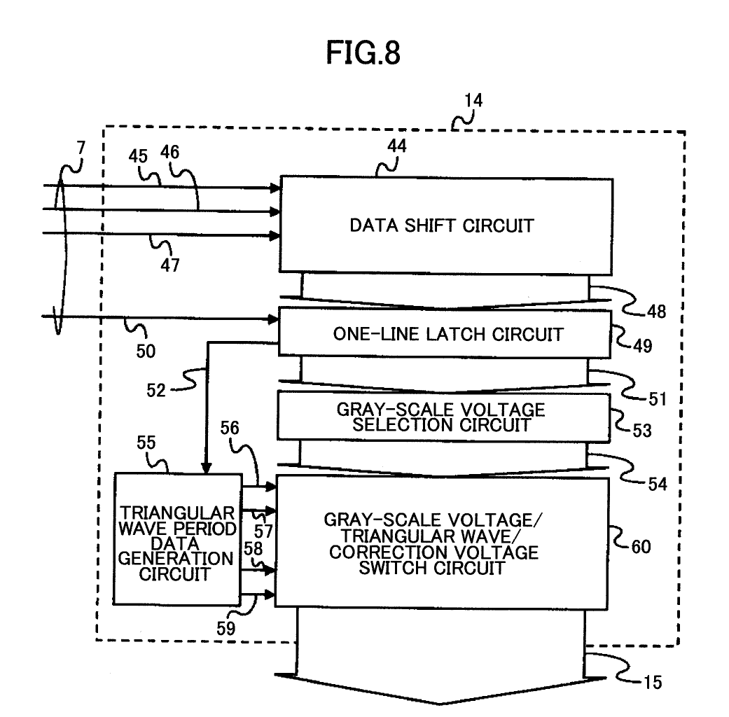

FIG. 8 is a block diagram illustrating an exemplary internal configuration of the data line drive circuit 14 included in the display device according to the first embodiment of the present invention. FIG. 8 illustrates a data shift circuit 44, a data start signal 45, a data clock 46, display serial data 47, display shift data 48, a one-line latch circuit 49, a horizontal latch clock 50, one-line latched data 51, a horizontal blanking period signal 52, a gray-scale voltage selection circuit 53, one-line display data 54, a triangular wave period data generation circuit 55, a triangular wave signal 56, a correction voltage 57, a triangular wave switch signal 58, a correction voltage switch signal 59, and a gray-scale voltage/triangular wave/correction voltage switch circuit 60.

In FIG. 8, with the data start signal 45 as a trigger of the capture start, the data shift circuit 44 captures the display serial data 47 for one line in synchronization with the data clock 46 in one horizontal period, and outputs the captured data as the display shift data 48.

The one-line latch circuit 49 latches the display shift data 48 corresponding to one line, and outputs the latched data as the one-line latched data 51 in synchronization with the horizontal latch clock 50 as well as outputting the horizontal blanking period signal 52 indicating a period in which no one-line latched data 51 is output.

The gray-scale voltage selection circuit 53 selects one level among 64 levels of the gray-scale voltage in accordance with the one-line latched data 51, and outputs the selected voltage as the one-line display data 54.

The triangular wave period data generation circuit 55 generates the triangular wave signal 56 having a one-frame period as one cycle, and the correction voltage 57 to be input via the correction switch 38 at the end of the emission period. Further, the triangular wave period data generation circuit 55 generates the triangular wave switch signal 58 indicating the output timing of the triangular wave signal 56, and the correction voltage switch signal 59 indicating the output timing of the correction voltage 57.

In accordance with the triangular wave switch signal 58 and the correction voltage switch signal 59, the gray-scale voltage/triangular wave/correction voltage switch circuit 60 switches among the one-line display data 54, the triangular wave signal 56, and the correction voltage 57 and outputs the switched one as the data line drive signal 15.

In other words, in the data line drive circuit 14 according to the first embodiment, for example, upon the inputs of the data start signal 45, the data clock 46, and the display serial data 47 as illustrated in FIGS. 7A to 7C, the display serial data 47 for one line is captured into the data shift circuit 44 in synchronization with the data clock 46, with the data start signal 45 as a trigger of the capture start. Every time the complete display serial data 47 for one line is obtained, the display serial data 47 is output to the one-line latch circuit 49 from the data shift circuit 44 as the display shift data 48. The display shift data 48 is latched for each line by the one-line latch circuit 49, and is output to the gray-scale voltage selection circuit 53 from the one-line latch circuit 49 as the one-line latched data 51 in synchronization with the horizontal latch clock 50 generated based on the data start signal 45 and the data clock 46, for example. At this time, from the one-line latch circuit 49, the horizontal blanking period signal 52 indicating a period in which no one-line latched data 51 is output is output to the triangular wave period data generation circuit 55.

Based on the one-line latched data 51, the gray-scale voltage selection circuit 53 selects one level among 64 levels of the gray-scale voltage for each pixel on one line. Then, a voltage value of the level selected for each pixel on one line is output to the gray-scale voltage/triangular wave/correction voltage switch circuit 60 as the one-line display data 54.

On the other hand, as described above, the triangular wave period data generation circuit 55 generates the triangular wave signal 56 having a cycle of a one-frame period, the correction voltage 57 to be input via the correction switch 38 at the end of the emission period, the triangular wave switch signal 58 indicating the output timing of the generated triangular wave signal 56, and the correction voltage switch signal 59 indicating the output timing of the generated correction voltage 57. The triangular wave signal 56, the correction voltage 57, the triangular wave switch signal 58, and the correction voltage switch signal 59 are output to the gray-scale voltage/triangular wave/correction voltage switch circuit 60.

In accordance with the triangular wave switch signal 58 and the correction voltage switch signal 59, the gray-scale voltage/triangular wave/correction voltage switch circuit 60 selects any one of the one-line display data 54, the triangular wave signal 56, and the correction voltage 57, and outputs the selected signal as the data line drive signal 15.

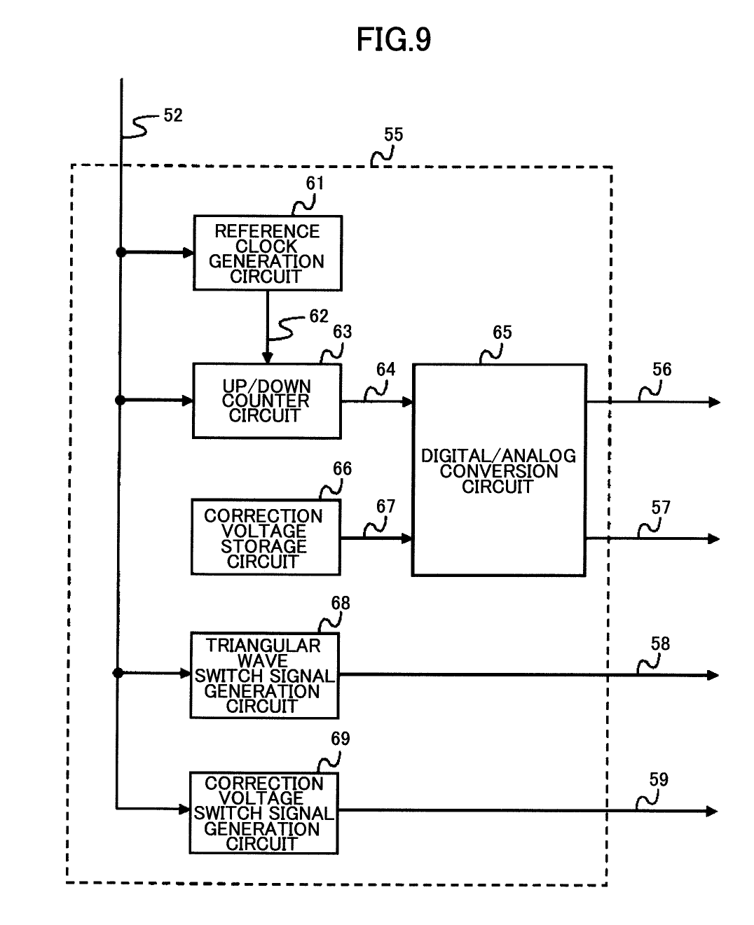

FIG. 9 is a block diagram illustrating an exemplary internal configuration of the triangular wave period data generation circuit 55 included in the display device according to the first embodiment of the present invention. FIG. 9 illustrates a reference clock generation circuit 61, a reference clock 62, an up/down counter circuit 63, a counter output 64, a digital/analog conversion circuit 65, a correction voltage storage circuit 66, correction voltage data 67, a triangular wave switch signal generation circuit 68, and a correction voltage switch signal generation circuit 69.

The reference clock generation circuit 61 illustrated in FIG. 9 generates the reference clock 62 for generating the triangular wave signal 56. The up/down counter circuit 63 counts down from an arbitrary initial value to “0” in synchronization with the reference clock 62 and then counts up again until the value returns to the initial value so as to output the counter output 64. The digital/analog conversion circuit 65 performs digital/analog conversion on the counter output 64, and outputs the converted counter output as the triangular wave signal 56.

The correction voltage storage circuit 66 is a location where the voltage level for correcting the gate voltage fluctuation of the drive inverter 37 described above is stored. The correction voltage storage circuit 66 outputs the stored value as the correction voltage data 67. The digital/analog conversion circuit 65 performs digital/analog conversion on the correction voltage data 67, and outputs the converted data as the correction voltage 57. In this embodiment, the following description is given assuming that the arbitrary initial value is set to “63”, which is a maximum value of 6-bit data similarly to the display data, and that the counter output 64 and the correction voltage data 67 are also 6-bit digital data.

The triangular wave switch signal generation circuit 68 generates the triangular wave switch signal 58 indicating the output timing of the triangular wave signal 56. The correction voltage switch signal generation circuit 69 generates the correction voltage switch signal 59 indicating the output timing of the correction voltage 57.

In other words, in the triangular wave period data generation circuit 55 according to the first embodiment, based on the horizontal blanking period signal 52 input from the one-line latch circuit 49, the reference clock generation circuit 61 generates the reference clock 62 for generating the triangular wave signal 56, and the reference clock 62 is then output to the up/down counter circuit 63. When supplied with the horizontal blanking period signal 52 and the reference clock 62, the up/down counter circuit 63 starts to operate with the horizontal blanking period signal 52 as a trigger, counts down from the arbitrary initial value to “0” in synchronization with the reference clock 62, and then counts up again until the value returns to the initial value so as to output the counter output 64 as a result of the counting to the digital/analog conversion circuit 65.

The counter output 64 is subjected to the digital/analog conversion by the digital/analog conversion circuit 65, and the converted analog voltage is output as the triangular wave signal 56. At this time, the digital/analog conversion circuit 65 performs digital/analog conversion also on the voltage level to be input from the correction voltage storage circuit 66 for correcting the gate voltage fluctuation, and then outputs the converted voltage as the correction voltage 57.

Further, based on the horizontal blanking period signal 52, the triangular wave switch signal generation circuit 68 generates and outputs the triangular wave switch signal 58 indicating the output timing of the correction voltage 57. Based on the horizontal blanking period signal 52, the correction voltage switch signal generation circuit 69 generates and outputs the correction voltage switch signal 59.

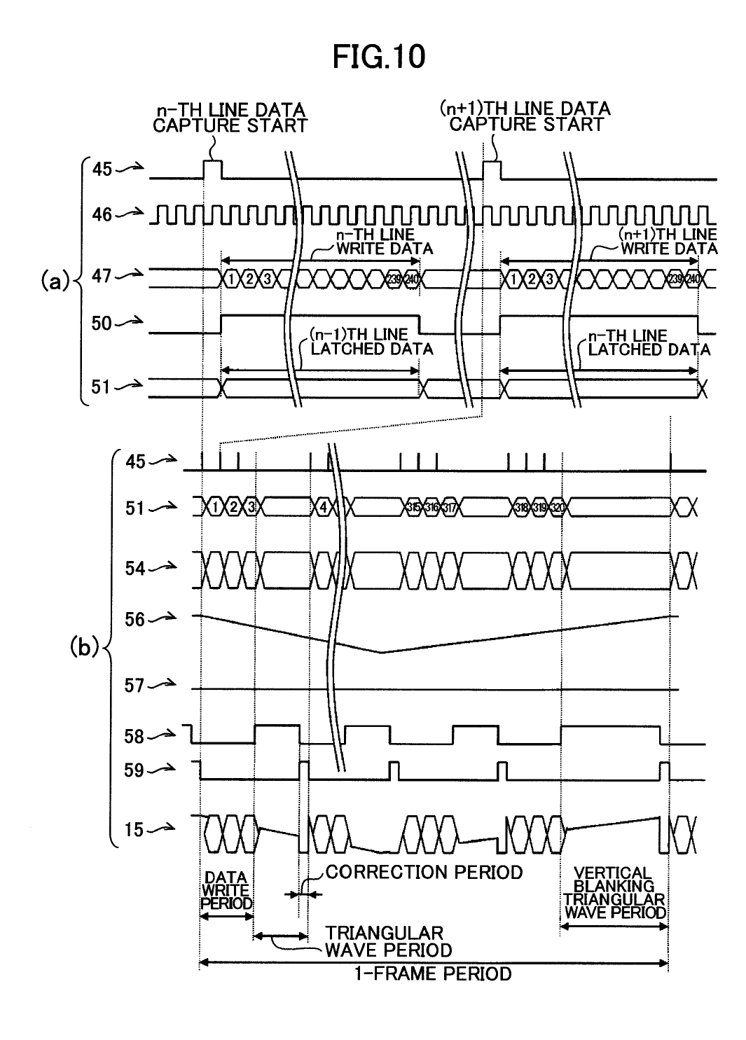

FIG. 10 is a waveform diagram illustrating an operation of the data line drive circuit 14 included in the display device according to the first embodiment of the present invention. A waveform group (a) illustrates signal waveforms related to the operation of outputting the display data of one horizontal period to be written into pixels, and a waveform group (b) illustrates waveforms in a one-frame period. In particular, the time line of the waveform group (a) is so expanded compared with the waveform group (b) as to illustrate a signal waveform which cannot be shown in the time scale of the waveform group (b).

The display serial data 47 illustrated in the waveform group (a) is captured into the data shift circuit 44 in synchronization with the data clock 46, with the pulse that sets the write data start signal 45 to “High” as a trigger of the capture start. For example, the n-th line display serial data 47 starts to be captured upon the rise of the data clock 46 for writing following the n-th line data capture start pulse. After all pieces of data for one line are captured, the data is output as the one-line latched data 51 in a period between the rise and fall of the horizontal latch clock 50. For example, the n-th line write data is output as the n-th line latched data upon the rise of the horizontal latch clock 50 following the capture start of data of a subsequent line.

As illustrated in the waveform group (b), the triangular wave switch signal 58 is set to “High” after the output of the one-line latched data 51 for three lines (for example, the first to third lines), and during “High” of the triangular wave switch signal 58, the triangular wave signal 56 is output as the data line drive signal 15. At the end of the emission period, the correction voltage switch signal 59 is set to “High”, and the correction voltage 57 is output as the data line drive signal 15. In other words, as the data line drive signal 15, the one-line display data 54 is output in the data write period while the triangular wave signal 56 and the correction voltage 57 are output in the triangular wave period. Further, in this embodiment, the vertical blanking period in each one-frame period is set as a vertical blanking triangular wave period in which the triangular wave signal is output, and at the end of the vertical blanking triangular wave period, a period in which the correction voltage 57 is output is provided.

As described above, in the display device according to the first embodiment, the drive circuit formed in each pixel of the self-luminous element display 20 is provided with the correction switch 38 for establishing connection between the data line and the gate terminal as the control terminal of the drive inverter 37 forming the drive circuit. The correction period is provided at the end of the triangular wave period in which light emission is performed. In the correction period, the potential of the data line is set to the correction potential that is a given preset potential, and the correction switch 38 is turned “ON”. Accordingly, the potential of the gate terminal of the drive inverter 37 is set once to the correction potential before subsequent data writing. Therefore, the gate voltage fluctuation of the drive inverter 37 caused after the light emission may be made constant to enable the sequential display voltage writing over the plurality of lines (three lines in this embodiment) to be performed with the uniform characteristics in each data write period, regardless of the order of writing.

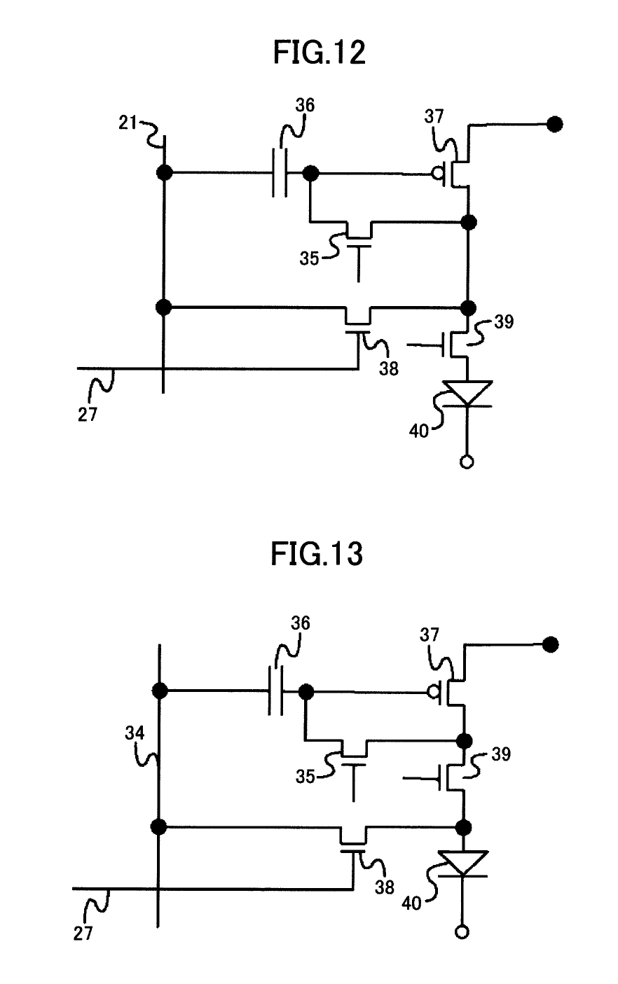

It should be noted that, according to the display device of the first embodiment, as illustrated in FIG. 2, the correction switch 38 is provided between the first data line 21 and the gate terminal as the control terminal of the drive inverter 37 so that the potential (correction voltage) of the first data line 21 may be set to GND when the correction switch 38 is turned “ON”, to thereby obtain the constant gate voltage fluctuation of the drive inverter 37. However, where to dispose the correction switch 38 is not limited to the position illustrated in FIG. 2, and may be a position as illustrated in FIG. 12 or FIG. 13 described later.

FIG. 12 is a circuit diagram illustrating another exemplary internal configuration of the pixels included in the display device according to the first embodiment of the present invention. The connection position of the correction switch 38 in the circuit illustrated in FIG. 12 is different from the connection position of the correction switch 38 in the pixel in first row and first column 31 described above with reference to FIG. 2. Specifically, in the configuration illustrated in FIG. 12, one terminal of the correction switch 38 is connected to the data line (first data line 21 in FIG. 12) similarly to the configuration of FIG. 2. However, unlike the configuration of FIG. 2, another terminal of the correction switch 38 is connected to an output terminal of the drive inverter 37, that is, a connection node between the drive inverter 37 and the emission control switch 39. It should be noted that, similarly to the configuration of FIG. 2, the reset switch 35 is connected between the output and input of the drive inverter 37.

In the case where the correction switch 38 is configured as illustrated in FIG. 12, when the correction switch 38 is turned ON by the correction pulse 601 illustrated in FIG. 6A, the reset switch 35 is also turned “ON” and the voltage Vin is set to GND. Through this operation, the gate voltage of the drive inverter 37 after the light emission is set once to the GND potential (given constant potential, correction voltage). In other words, the gate voltage fluctuation of the drive inverter 37 caused after the light emission may be made constant to enable the display voltage writing immediately after the light emission and the subsequent display voltage writing to be performed with the same characteristics.

FIG. 13 is a circuit diagram illustrating still another exemplary internal configuration of the pixels included in the display device according to the first embodiment of the present invention.

The connection position of the correction switch 38 in the circuit illustrated in FIG. 13 is different from the connection position of the correction switch 38 in the pixel in first row and first column 31 described above with reference to FIG. 2. Specifically, in the configuration illustrated in FIG. 13, one terminal of the correction switch 38 is connected to the data line similarly to the configuration of FIG. 2. However, unlike the configuration of FIG. 2, another terminal of the correction switch 38 is connected to the anode of the organic EL element 40, that is, a connection node between the emission control switch 39 and the organic EL element 40. It should be noted that, similarly to the configuration of FIG. 2, the reset switch 35 is connected between the output and input of the drive inverter 37.

In the case where the correction switch 38 is configured as illustrated in FIG. 13, when the correction switch 38 is turned ON by the correction pulse 601 illustrated in FIG. 6A, the reset switch 35 and the emission control switch 39 are also turned “ON” and the voltage Vin is set to the correction voltage, that is, GND. Through this operation, the gate voltage of the drive inverter 37 after the light emission is set once to the GND potential (given constant potential, correction voltage). In other words, the gate voltage fluctuation of the drive inverter 37 caused after the light emission may be made constant to enable the display voltage writing immediately after the light emission and the subsequent display voltage writing to be performed with the same characteristics.

Further, in the display device according to the first embodiment, as the correction voltage to be supplied to the data line at the input timing of the correction pulse, the GND level voltage is output from an output amplifier of the digital/analog conversion circuit. However, how to supply the correction voltage is not limited thereto. For example, there may be employed a configuration in which a switch for connecting the data line to a signal line of GND is provided so that the switch may be turned “ON” at the input timing of the correction pulse to allow the data line to have the GND level potential.

### Second Embodiment

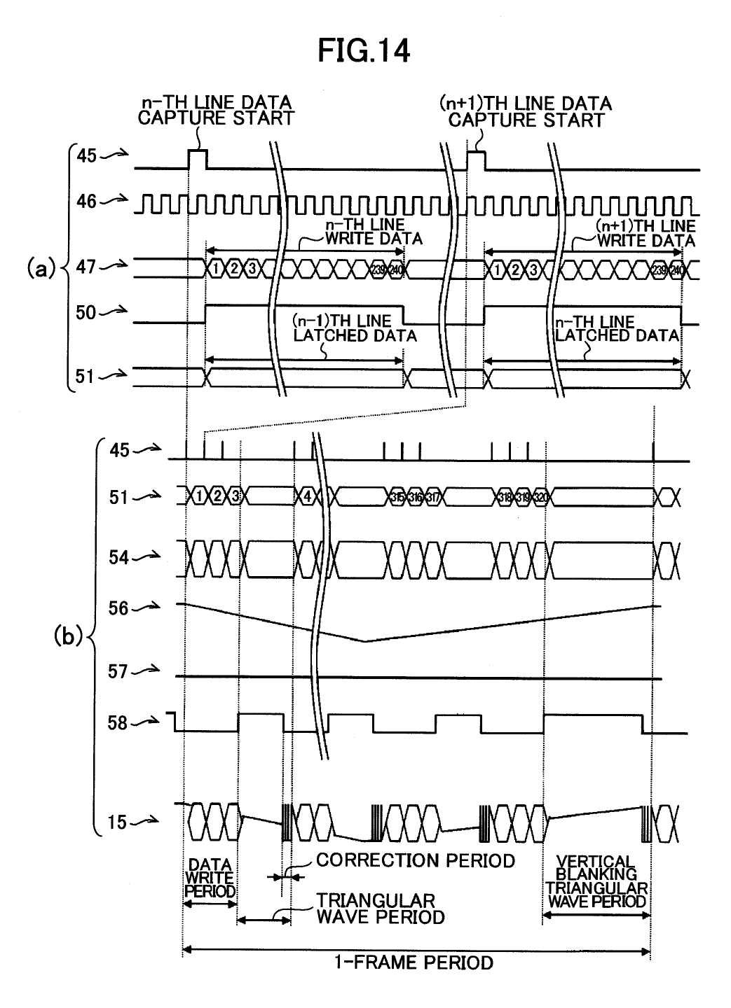

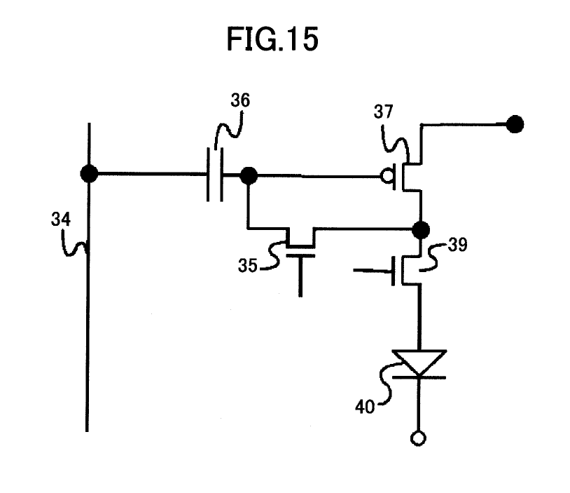

FIG. 14 is a waveform diagram illustrating an operation of a data line drive circuit included in a display device according to a second embodiment of the present invention. FIG. 15 is a circuit diagram illustrating an internal configuration of pixels included in the display device according to the second embodiment of the present invention. In FIG. 14, a waveform group (a) illustrates signal waveforms related to the operation of outputting the display data of one horizontal period to be written into the pixels, and a waveform group (b) illustrates waveforms in a one-frame period. In particular, the time line of the waveform group (a) is so expanded compared with the waveform group (b) as to illustrate a signal waveform which cannot be shown in the time scale of the waveform group (b). The display device of this embodiment is different from the display device of the first embodiment in that no correction switch is provided and the control terminal of the drive inverter is set to the correction voltage via the write capacitor. Other configurations than the above are the same as in the display device according to the first embodiment. Therefore, description is given in detail below of the features of the configuration of the display device according to the second embodiment in which the correction voltage is applied to the control terminal of the drive inverter via the write capacitor and accordingly no correction switch is required for the application of the correction voltage.

In the pixel according to the second embodiment illustrated in FIG. 15, one terminal of a drive inverter 37 is connected to an emission voltage supply line (not shown), and another terminal thereof is connected to one terminal of an emission control switch 39 as a switch element. Another terminal of the emission control switch 39 is connected to an anode of an organic EL element 40 as a self-luminous element. A gate terminal of the emission control switch 39 is connected to an emission control line (not shown). A cathode of the organic EL element 40 is connected to the ground.

A reset switch 35 is connected between the another terminal and a gate terminal of the drive inverter 37. A gate terminal of the reset switch 35 is connected to a scanning line (not shown). A connection node between the reset switch 35 and the gate terminal of the drive inverter 37 is connected to one terminal of a write capacitor 36, and another terminal of the write capacitor 36 is connected to a data line 34. As described above, the pixel configuration of the display device according to the second embodiment is the same as the pixel configuration of the conventional display device.

Next, referring to FIGS. 14 and 8, the operation of the data line drive circuit included in the display device according to the second embodiment is described.

As illustrated in the waveform group (a) of FIG. 14, in the data line drive circuit according to the second embodiment, when the n-th line data is captured by the data shift circuit 44, the (n−1)th line data is already latched in the one-line latch circuit. Therefore, the operation of the data line drive circuit in the data write period illustrated in the waveform group (b) of FIG. 14 is the same as the operation of the data line drive circuit according to the first embodiment.

As illustrated in the waveform group (b) of FIG. 14, the data write period is followed by the triangular wave period. In the triangular wave period, a shift period of a given length is first provided and thereafter an emission allocated period is ensured. The above-mentioned operation is the same as in the data line drive circuit according to the first embodiment.

Also in the data line drive circuit according to the second embodiment, the correction period is provided after the emission allocated period. In the correction period, the triangular wave switch signal 58 is switched from “High” to “Low”, and signals of preset voltage levels are continuously output a plurality of times to the data line as the data line drive signals 15. In other words, the data line drive circuit according to the second embodiment outputs an alternating voltage to the data line in the correction period.

The application of the alternating data line drive signal 15 in the correction period of the display device according to the second embodiment is performed by means of coupling to the write capacitor 36 so that the gate voltage of the drive inverter 37 immediately after light emission may be set to a given potential. Because of the correction period provided before the data write period, the gate voltage fluctuation of the drive inverter 37 caused immediately after the light emission may be made constant. As a result, the display voltage writing immediately after the light emission and the subsequent sequential display voltage writing may be performed with the same characteristics.

As described above, in the display device according to the second embodiment, the correction period is provided at the end of the triangular wave period as the emission period, and in the correction period, the signals of the preset voltage levels are continuously applied to the write capacitor 36 a plurality of times. Then, using the capacitive coupling, the gate terminal potential of the drive inverter 37 is set to the correction potential, and thereafter subsequent data writing is performed. The display device according to the second embodiment configured as described above may also provide the same effect as in the display device according to the first embodiment.

In addition, the display device according to the second embodiment is capable of setting the gate terminal potential of the drive inverter 37 to the correction potential only by means of the output of the data line drive circuit 14. Therefore, such a special effect can be obtained that the drive circuit for driving the organic EL element and hence the pixels are simplified.

It should be noted that, in the display device according to each of the first and second embodiments, the present invention has been described exemplifying the case where the triangular wave is used as a voltage that varies in an arbitrary cycle (control voltage), but the control voltage is not limited thereto. For example, in place of the triangular wave, such a voltage as to exhibit a non-linear wave gradually increasing or decreasing along with a display straight line may be used to emphasize or de-emphasize the gray-scale change for display. Further, the time modulation is not limited to the one using the triangular wave, and the present invention is also applicable to a display device having a configuration in which a gate voltage level of the drive inverter is used to control a current flowing through the organic EL element.

Further, by the operation of the display device according to each of the first and second embodiments, the self-luminous element display that performs gray-scale control by means of horizontal blanking emission requiring no frame memory is capable of prolonging an emission time to perform high-brightness image display.

The present invention is a technology applicable to display devices of a mobile phone, a digital still camera (DSC), and an information processing terminal such as a personal digital assistant (PDA), as well as to large-sized display devices such as a TV set and an information signboard.

The invention devised by the inventors of the present invention has been specifically described above by way of the above-mentioned embodiments of the invention. However, the present invention is not limited to the above-mentioned embodiments of the invention, and various modifications may be made thereto without departing from the gist of the invention.

What is claimed is:

1. A display device, comprising:
a display portion comprising:
a plurality of pixels arrayed in a matrix of rows and columns, the plurality of pixels each comprising a self-luminous element and a drive element for supplying a current to the self-luminous element;
a plurality of data lines for supplying a display signal voltage to the plurality of pixels; and
a plurality of scanning lines intersecting with the plurality of data lines; and
a data line drive circuit for providing a first period in which the display signal voltage in accordance with display data is output to the plurality of data lines, and a second period in which a control voltage for controlling the drive element to control light emission of the self-luminous element is output to the plurality of data lines, to thereby supply the display signal voltage and the control voltage to the plurality of pixels,
wherein the data line drive circuit further provides, after the second period, a third period in which a given voltage signal is applied to a control terminal of the drive element, and
wherein the data line drive circuit is configured to:
output the display signal voltage in accordance with the display data in the first period;
output the control voltage for controlling the light emission of the self-luminous element in the second period; and
output the given voltage signal for setting the control terminal of the drive element to have a given correction voltage in the third period.

2. The display device according to claim 1,
wherein the drive element comprises a semiconductor element including:
at least one terminal connected to a power supply line for supplying power for the light emission;
another terminal connected to the self-luminous element; and
a control terminal connected to a corresponding one of the plurality of data lines via a capacitor element, and
wherein, in the third period, the data line drive circuit outputs an alternating voltage as the given voltage signal and sets the control terminal of the semiconductor element to have the given correction voltage via the capacitor element.

3. The display device according to claim 1, further comprising:
a scanning line control circuit for controlling to write the display signal voltage into the plurality of pixels,
wherein the drive element comprises a semiconductor element including:
at least one terminal connected to a power supply line for supplying power for the light emission;
another terminal connected to the self-luminous element; and
a control terminal connected to a corresponding one of the plurality of data lines via a capacitor element,
wherein the each of the plurality of pixels further comprises a switching element for controlling electrical connection between the control terminal of the semiconductor element and the corresponding one of the plurality of data lines,
wherein the data line drive circuit outputs a given constant voltage as the given voltage signal in the third period, and
wherein the scanning line control circuit controls the switching element so that the given constant voltage is applied to the control terminal of the semiconductor element.

4. The display device according to claim 1,
wherein the plurality of scanning lines are grouped into a plurality of groups each including a plurality of the scanning lines, and
wherein the data line drive circuit is configured to, for each of the plurality of groups obtained by grouping the plurality of scanning lines:
output the display signal voltage in accordance with the display data in the first period;
output the control voltage for controlling the light emission of the self-luminous element in the second period; and
output the given voltage signal for setting the control terminal of the drive element to have the given correction voltage in the third period.

5. The display device according to claim 4, wherein the plurality of scanning lines are grouped into a plurality of groups each including at least two scanning lines.

6. The display device according to claim 1, further comprising GND signal lines,
wherein the data line drive circuit comprises a switch for connecting the plurality of data lines to a GND signal line in the third period.

7. The display device according to claim 1, wherein the control voltage comprises a triangular wave that varies in level in a one-frame cycle.

8. A driving method for a display device,
the display device comprising:
a plurality of pixels arrayed in a matrix of rows and columns, the plurality of pixels each comprising a self-luminous element and a drive element for supplying a current to the self-luminous element;
a plurality of data lines for supplying a display signal voltage to the plurality of pixels; and
a plurality of scanning lines intersecting with the plurality of data lines,
the driving method comprising sequentially repeating:
a first period in which the display signal voltage in accordance with display data is output to the plurality of data lines;
a second period in which a control voltage for controlling the drive element to control light emission of the self-luminous element is output to the plurality of data lines; and
a third period in which a given voltage signal is applied to a control terminal of the drive element.

9. The driving method for a display device according to claim 8,
the drive element comprising a semiconductor element including:
at least one terminal connected to a power supply line for supplying power for the light emission;
another terminal connected to the self-luminous element; and
a control terminal connected to a corresponding one of the plurality of data lines via a capacitor element,
wherein the third period is provided for outputting an alternating voltage as the given voltage signal to the plurality of data lines and setting the control terminal of the semiconductor element to have a given potential via the capacitor element.

10. The driving method for a display device according to claim 8,
the display device further comprising scanning line control means for controlling to write the display signal voltage into the plurality of pixels,
the drive element comprising a semiconductor element including:
at least one terminal connected to a power supply line for supplying power for the light emission;
another terminal connected to the self-luminous element; and
a control terminal connected to a corresponding one of the plurality of data lines via a capacitor element,
each of the plurality of pixels further comprising a switching element for controlling electrical connection between the control terminal of the semiconductor element and the corresponding one of the plurality of data lines,
wherein the third period is provided for:
outputting a given constant voltage as the given voltage signal; and
controlling the the switching element so that the given constant voltage is applied to the control terminal of the semiconductor element.

11. The driving method for a display device according to claim 8,
wherein the plurality of scanning lines are grouped into a plurality of groups each including a plurality of the scanning lines, and
wherein the first period, the second period, and the third period are sequentially repeated for each of the plurality of groups obtained by grouping the plurality of scanning lines.

12. The driving method for a display device according to claim 11, wherein the plurality of scanning lines are grouped into a plurality of groups each including at least two scanning lines.

13. The driving method for a display device according to claim 8, wherein the display device further comprises a switch for connecting the plurality of data lines to a GND signal line in the third period.

14. The driving method for a display device according to claim 8, wherein the control voltage comprises a triangular wave that varies in level in a one-frame cycle.
